(19) United States
(12) Patent Application Publication
(10) Pub. No.: US 2023/0314612 A1
(43) Pub. Date: Oct. 5, 2023

(54) SENSOR UNIT, CONTROL METHOD, AND NON-TRANSITORY COMPUTER READABLE MEDIUM STORING PROGRAM

(71) Applicant: OMRON Corporation, Kyoto-shi (JP)

(72) Inventor: Shintaro IWAMOTO, Kyoto-shi (JP)

(21) Appl. No.: 18/186,987

(22) Filed: Mar. 21, 2023

(30) Foreign Application Priority Data
Apr. 1, 2022 (JP) 2022-062018

(51) Int. Cl. G01S 17/42; G01S 7/51

(52) U.S. Cl. CPC G01S 17/42; G01S 7/51

(57) ABSTRACT

A sensor unit includes a determination unit that performs at least one of first determination of determining whether or not a distance to an object is included in a first distance range from a first predetermined distance to a second predetermined distance and second determination of determining whether or not the distance to the object is included in a second distance range from a third predetermined distance to a fourth predetermined distance, a generation unit that generates information regarding positional displacement of the object in a case where the distance to the object is determined a predetermined number of times to be included in the first distance range or in a case where the distance to the object is determined a predetermined number of times to be included in the second distance range, and a display that displays the information regarding positional displacement of the object.

### CROSS-REFERENCE TO RELATED APPLICATIONS

This application is based on Japanese Patent Application No. 2022-062018 filed with the Japan Patent Office on Apr. 1, 2022, the entire contents of which are incorporated herein by reference.

### FIELD OF THE INVENTION

The present invention relates to a sensor unit of a reflective type has a ranging function by observing an electromagnetic wave reflected by an object.

### BACKGROUND OF THE INVENTION

There is known a sensor of a reflective type that measures a distance to an object by irradiating with electromagnetic waves such as light and a radio wave and observing reflected electromagnetic waves reflected by the object. Japanese Patent Application Laid-Open No. 2021-196342 discloses a distance measuring device that measures a distance to an object by a time of flight (ToF) method.

### SUMMARY OF THE INVENTION

Also in the field of factory automation (FA), a sensor of a reflective type is widely used to detect a human or an object. For example, a sensor unit called a safety laser scanner is a type of safety sensor that detects intrusion of a person or an object into a predetermined monitoring area and outputs a signal to stop a device.

A safety sensor may have a function of setting a predetermined position of an object such as a frame or a column of an opening as a reference point, always detecting the reference point, and turning off control output when an abnormality occurs. Such a function is called “reference point monitoring function”, “contour detection function”, “reference boundary function”, “reference boundary monitoring”, “contour as reference”, or the like. For example, a reference point set at a predetermined position of an object is constantly monitored, and control output is turned on at the normal time. In a case where a reference point at a predetermined position cannot be seen due to intrusion of an object into a monitoring area, or in a case where a gap is generated between the monitoring area and an object due to positional displacement of the object or the like and the reference point is displaced by a certain amount, control output is turned off and a device is stopped. However, when a device suddenly stops due to positional displacement of an object, work is interrupted, and work efficiency is lowered.

The present invention has been made in view of the above circumstances, and an object of the present invention is to provide a technique capable of grasping positional displacement of an object before a device stops due to the positional displacement of the object.

A sensor unit according to one aspect of the present invention is a sensor unit including a sensor configured to measure a distance to an object by observing an electromagnetic wave reflected by the object, a determination unit configured to perform at least one of first determination of determining whether or not the distance to the object is included in a first distance range from a first predetermined distance to a second predetermined distance longer than the first predetermined distance and second determination of determining whether or not the distance to the object is included in a second distance range from a third predetermined distance longer than the second predetermined distance to a fourth predetermined distance longer than the third predetermined distance, a generation unit configured to generate information regarding positional displacement of the object in a case where the distance to the object is determined a predetermined number of times to be included in the first distance range or in a case where the distance to the object is determined a predetermined number of times to be included in the second distance range, and a display configured to display the information regarding positional displacement of the object. When the user visually recognizes the information regarding positional displacement of an object displayed on the display, the user can grasp the positional displacement of the object before an external device stops. By the above, it is possible to grasp positional displacement of the object before the external device stops due to the positional displacement of the object.

The determination unit may be configured to perform third determination to determine whether or not the distance to the object is included in a third distance range from the second predetermined distance to the third predetermined distance, and the generation unit may be configured not to generate the information regarding positional displacement of the object in a case where the distance to the object is determined a predetermined number of times to be included in the third distance range. In a case where a distance to an object is determined a predetermined number of times to be included in the third distance range, since positional displacement of the object does not occur, the information regarding positional displacement of the object is not generated.

An electromagnetic wave reflected by the object may include light, the sensor may be configured to measure a received light amount of light reflected by the object, the determination unit is configured to determine whether or not the received light amount is included in a predetermined range, the generation unit may be configured to generate information regarding fluctuation in the received light amount in a case where the received light amount is determined a predetermined number of times not to be included in the predetermined range, and the display may be configured to display the information regarding fluctuation in the received light amount. By the user visually recognizing the information regarding fluctuation in a received light amount displayed on the display, the user can grasp fluctuation in the received light amount before an external device stops. By the above, it is possible to grasp the fluctuation in the received light amount before the external device stops due to the fluctuation in the received light amount.

The sensor may be configured to measure a plurality of directions, the determination unit may be configured to determine whether or not the received light amount in a plurality of the directions is included in the predetermined range, and the generation unit may be configured to generate the information regarding fluctuation in the received light amount in a case where the received light amount in one of a plurality of the directions is determined a predetermined number of times not to be included in the predetermined range. By the above, the user can grasp that the received light amount in one of a plurality of directions fluctuates.

The sensor may be configured to measure a plurality of directions, the determination unit may be configured to determine whether or not the received light amount in a plurality of the directions is included in the predetermined range, and the generation unit may be configured to generate the information regarding fluctuation in the received light amount in a case where the received light amount in at least two of a plurality of the directions is determined a predetermined number of times not to be included in the predetermined range. By the above, the user can grasp that the received light amount in at least two of a plurality of directions fluctuates.

The sensor may be configured to measure a plurality of directions, the determination unit may be configured to perform at least one of the first determination and the second determination on the plurality of directions, and the generation unit may be configured to generate the information regarding positional displacement of the object in a case where the distance to the object in one of a plurality of the directions is determined a predetermined number of times to be included in the first distance range, or in a case where the distance to the object in one of a plurality of the directions is determined a predetermined number of times to be included in the second distance range. By the above, the user can grasp the positional displacement of the object in one of a plurality of directions.

The sensor may be configured to measure a plurality of directions, the determination unit may be configured to perform at least one of the first determination and the second determination on the plurality of directions, and the generation unit may be configured to generate the information regarding positional displacement of the object in a case where the distance to the object in at least two of a plurality of the directions is determined a predetermined number of times to be included in the first distance range, or in a case where the distance to the object in at least two of a plurality of the directions is determined a predetermined number of times to be included in the second distance range. By the above, the user can grasp the positional displacement of the object in at least two of a plurality of directions.

The determination unit may be configured to perform at least one of fourth determination of determining whether or not the distance to the object is shorter than the first predetermined distance and fifth determination of determining whether or not the distance to the object is longer than the fourth predetermined distance, and the generation unit may be configured to generate a stop signal for stopping an external device and sends the stop signal to the external device in a case where the distance to the object is determined a predetermined number of times to be shorter than the first predetermined distance or in a case where the distance to the object is determined a predetermined number of times to be longer than the fourth predetermined distance. By the above, in a case where positional displacement of an object exceeds an allowable range, an external device can be stopped.

The sensor may be configured to measure a plurality of directions, the determination unit may be configured to perform at least one of the fourth determination and the fifth determination on the plurality of directions, and the generation unit may be configured to generate the stop signal and sends the stop signal to the external device in a case where the distance to the object in one of the plurality of directions is determined a predetermined number of times to be shorter than the first predetermined distance or in a case where the distance to the object in one of the plurality of directions is determined a predetermined number of times to be longer than the fourth predetermined distance. By the above, in a case where positional displacement of an object in one of a plurality of directions exceeds an allowable range, an external device can be stopped.

The sensor may be configured to measure a plurality of directions, the determination unit may be configured to perform at least one of the fourth determination and the fifth determination on the plurality of directions, and the generation unit may be configured to generate the stop signal and sends the stop signal to the external device in a case where the distance to the object in at least two of a plurality of the directions is determined a predetermined number of times to be shorter than the first predetermined distance or in a case where the distance to the object in at least two of a plurality of the directions is determined a predetermined number of times to be longer than the fourth predetermined distance. By the above, in a case where positional displacement of an object in at least two of a plurality of directions exceeds an allowable range, an external device can be stopped.

A control method of a sensor unit according to one aspect of the present invention is a control method including a measuring step of measuring a distance to an object by observing an electromagnetic wave reflected by the object, a determining step of performing at least one of first determination of determining whether or not the distance to the object is included in a first distance range from a first predetermined distance to a second predetermined distance longer than the first predetermined distance and second determination of determining whether or not the distance to the object is included in a second distance range from a third predetermined distance longer than the second predetermined distance to a fourth predetermined distance longer than the third predetermined distance, a generating step of generating information regarding positional displacement of the object in a case where the distance to the object is determined a predetermined number of times to be included in the first distance range or in a case where the distance to the object is determined a predetermined number of times to be included in the second distance range, and a displaying step of displaying the information regarding positional displacement of the object on a display.

A non-transitory computer readable medium storing a program according to one aspect of the present invention is a program that causes a processor to execute an acquiring step of acquiring measurement data from a sensor that measures a distance to an object by observing an electromagnetic wave reflected by the object, a determining step of performing at least one of first determination of determining whether or not the distance to the object is included in a first distance range from a first predetermined distance to a second predetermined distance longer than the first predetermined distance and second determination of determining whether or not the distance to the object is included in a second distance range from a third predetermined distance longer than the second predetermined distance to a fourth predetermined distance longer than the third predetermined distance, a generating step of generating information regarding positional displacement of the object in a case where the distance to the object is determined a predetermined number of times to be included in the first distance range or in a case where the distance to the object is determined a predetermined number of times to be included in the second distance range, and a displaying step of displaying the information regarding positional displacement of the object on a display.

The present invention may be regarded as a sensor system having at least a part of the above means or functions, or may be regarded as a safety system or an FA system having the sensor system. Further, the present invention may be regarded as a control method of a sensor unit including at least a part of the above processing, or may be regarded as a detection method of a sensor unit. Furthermore, the present invention can also be regarded as a program for realizing such a method and a computer-readable recording medium in which the program is recorded non-temporarily. Note that each of the means and the processing can be combined with each other as much as possible to constitute the present invention.

According to the present invention, it is possible to grasp positional displacement of an object before a device stops due to the positional displacement of the object.

### BRIEF DESCRIPTION OF THE DRAWINGS

FIG. 1 is a diagram illustrating a configuration of a sensor unit;

FIG. 2 is a diagram illustrating an example of installation of the sensor unit;

FIG. 3 is a diagram illustrating an example of installation of the sensor unit;

FIG. 4 is a schematic view of the sensor unit as viewed from a side surface side;

FIG. 5 is a schematic view of the sensor unit as viewed from the side surface side;

FIG. 6 is a schematic view of the sensor unit as viewed from the side surface side;

FIG. 7 is a block diagram of a sensor;

FIG. 8 is a diagram illustrating an example of a time chart of a signal;

FIG. 9 is a diagram illustrating an example of a time chart of a signal;

FIG. 10 is a functional block diagram of a processor;

FIG. 11 is a flowchart illustrating an example of setting processing of reference point monitoring;

FIG. 12 is a flowchart illustrating an example of reference point monitoring processing;

FIG. 13 is a diagram illustrating an example of a screen of a display device; and

FIG. 14 is a diagram illustrating an example of setting of a stop area and a warning area.

### DETAILED DESCRIPTION

Hereinafter, an application example and an embodiment will be described with reference to the drawings. The application example and embodiment are one aspect of the present application, and do not limit the scope of rights of the present application.

### Application Example

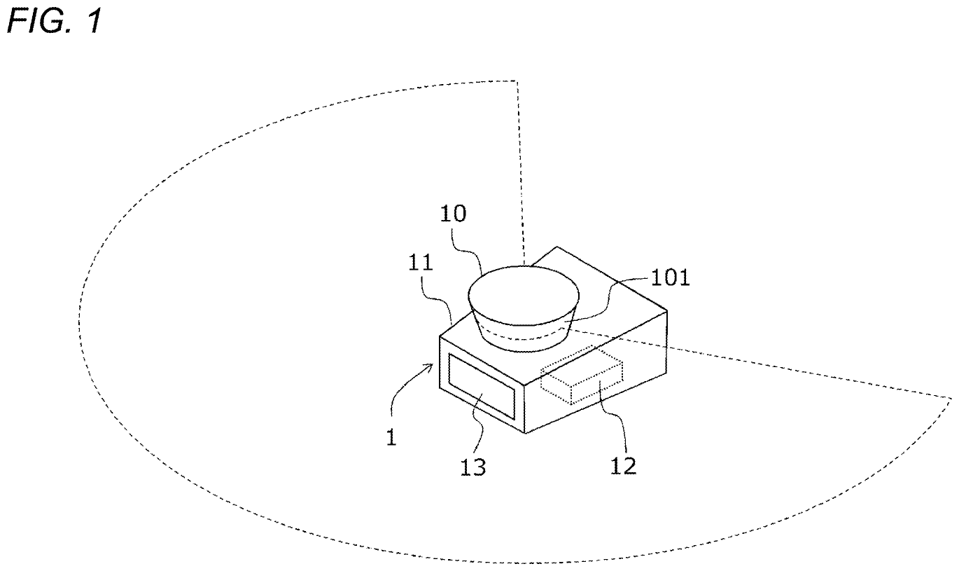

One application example of the present invention will be described with reference to FIGS. 1 to 6. FIG. 1 is a diagram illustrating a configuration of a sensor unit (sensor system) 1. The sensor unit 1 includes a sensor 10 of a reflective type, a main body 11, a processor 12 that performs predetermined processing, and a display device 13 capable of displaying predetermined information. The sensor unit 1 may have an integrated configuration in which the processor 12 and the display device 13 are provided in one casing, or may have a configuration in which the processor 12 and the display device 13 are separated and connected in a wired or wireless manner. In the configuration example illustrated in FIG. 1, the processor 12 is provided in the main body 11, and the display device 13 is provided on an outer surface of the main body 11. The display device 13 is an example of a display.

In the present specification, the “sensor of a reflective type” means a sensor capable of measuring a distance to an object by observing an electromagnetic wave reflected by the object, and includes, for example, a distance measuring sensor (LiDAR or the like) using laser light and a distance measuring sensor (millimeter wave radar or the like) using radio waves. An electromagnetic wave reflected by an object includes light. A measurement system of the sensor of a reflective type may be any system, and examples of the measurement system include a ToF system and a triangulation system. In order to measure objects in a plurality of directions, an area sensor having a two-dimensional measurement area (visual field) or a three-dimensional measurement area (visual field) is used.

The sensor unit 1 is also called a safety laser scanner or a laser scanner, and is a safety sensor conforming to a safety standard such as ISO13849-1. The sensor 10 generally has a structure in which a window 101 having an inverted truncated cone shape is provided on the main body 11. In addition to the processor 12 and the display device 13, the main body 11 is provided with a light source, an optical system, a light receiving device, and the like that are a part of the sensor 10. The window 101 is made from a material that transmits laser light, and is a member for protecting an optical system such as a polygon mirror. Laser light output from a light source is reflected by a polygon mirror rotating at a high speed inside the window 101, so that the sensor 10 can scan a direction of about 270 degrees around. In this manner, the sensor 10 can measure a plurality of directions. That is, the sensor 10 can measure a distance to an object in a plurality of directions. Further, the sensor 10 measures a distance to an object at predetermined intervals (regular or irregular intervals). The processor 12 compares a distance to an object measured by the sensor 10 with a set predetermined distance, and performs predetermined processing on the basis of a comparison result.

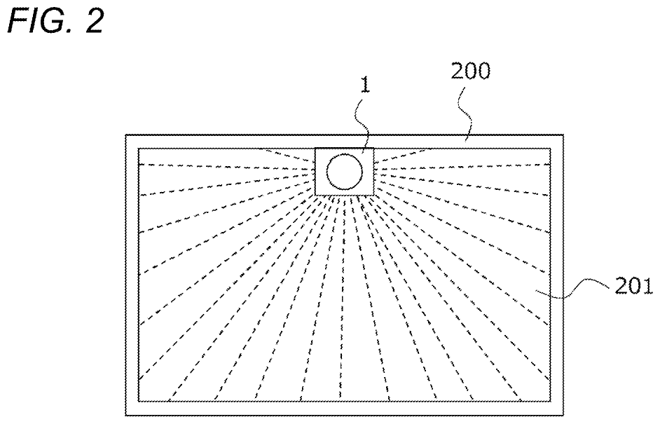

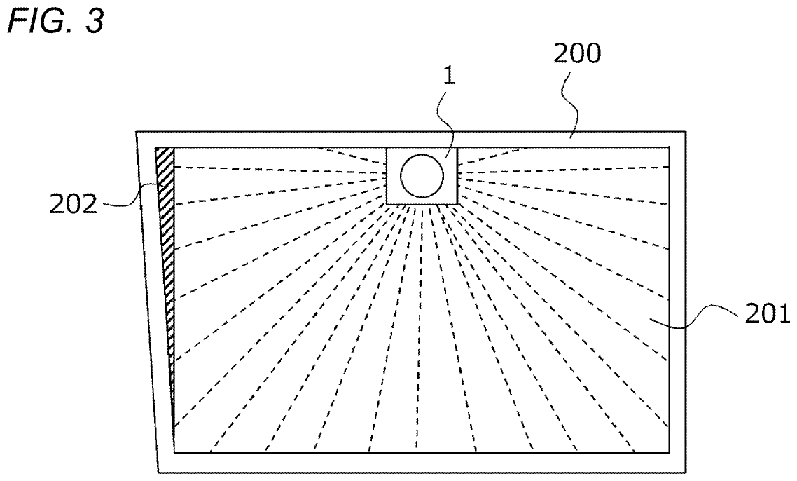

FIG. 2 is a diagram illustrating an example of installation of the sensor unit 1. In the example illustrated in FIG. 2, the sensor unit 1 is provided in a frame 200, and a monitoring area 201 is set inside the frame 200. The monitoring area 201 is an area set using each predetermined point of the frame 200 as a reference point. The sensor unit 1 constantly monitors the monitoring area 201. When a person or an object enters the monitoring area 201, the sensor unit 1 outputs a stop signal to an external device (external equipment). The external device is, for example, a device such as a robot or a press machine, but is not limited to these. Further, as illustrated in FIG. 3, there is a case where positional displacement of the frame 200 occurs due to inclination of the frame 200, and a gap 202 is generated between the frame 200 and the monitoring area 201. In a case where a reference point monitoring function is enabled, a stop signal is output from the sensor unit 1 to an external device. When an external device suddenly stops due to generation of the gap 202 between the frame 200 and the monitoring area 201, work is interrupted and work efficiency is lowered.

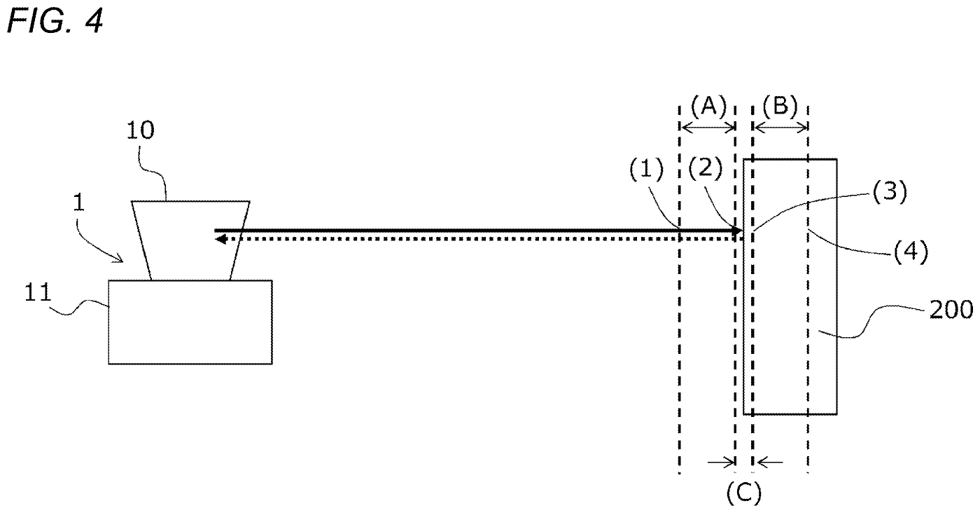

In view of the above, in the sensor unit 1, the processor 12 detects positional displacement of an object, and the display device 13 displays the positional displacement of the object, so that the user can grasp the positional displacement of the object before an external device stops. Hereinafter, an example of detecting positional displacement of an object will be described with reference to FIGS. 4 to 6.

FIGS. 4 to 6 are schematic diagrams when the sensor unit 1 is viewed from the side surface side. The processor 12 performs first determination to determine whether or not a distance to an object is included in a first distance range from a first predetermined distance to a second predetermined distance longer than the first predetermined distance. In FIGS. 4 to 6, a distance (hereinafter referred to as distance L1) from the position of the sensor 10 to a predetermined position (1) is an example of the first predetermined distance. In FIGS. 4 to 6, a distance (hereinafter referred to as distance L2) from the position of the sensor 10 to a predetermined position (2) is an example of the second predetermined distance. In FIGS. 4 to 6, a range (A) from the distance L1 to the distance L2 is an example of the first distance range. The processor 12 determines whether or not a distance to the frame 200 is included in the range (A) from the distance L1 to the distance L2. That is, the processor 12 determines whether or not the position of the frame 200 is included in the range (A) from the predetermined position (1) to the predetermined position (2). The position of the frame 200 is the position of an object to be measured by the sensor unit 1.

Furthermore, the processor 12 performs second determination to determine whether or not a distance to an object is included in a second distance range from a third predetermined distance to a fourth predetermined distance longer than the third predetermined distance. In FIGS. 4 to 6, a distance (hereinafter referred to as distance L3) from the position of the sensor 10 to a predetermined position (3) is an example of the third predetermined distance. In FIGS. 4 to 6, a distance (hereinafter referred to as distance L4) from the position of the sensor 10 to a predetermined position (4) is an example of the fourth predetermined distance. In FIGS. 4 to 6, a range (B) from the distance L3 to the distance L4 is an example of the second distance range. The processor 12 determines whether or not a distance to the frame 200 is included in the range (B) from the distance L3 to the distance L4. That is, the processor 12 determines whether or not the position of the frame 200 is included in the range (B) from the predetermined position (3) to the predetermined position (4).

The processor 12 performs at least one of the first determination and the second determination. In a case where a distance to an object is determined a predetermined number of times to be included in the first distance range or in a case where the distance to the object is determined a predetermined number of times to be included in the second distance range, the processor 12 generates information regarding positional displacement of the object. The predetermined number of times can be set to any number of times, and may be once or a plurality of times.

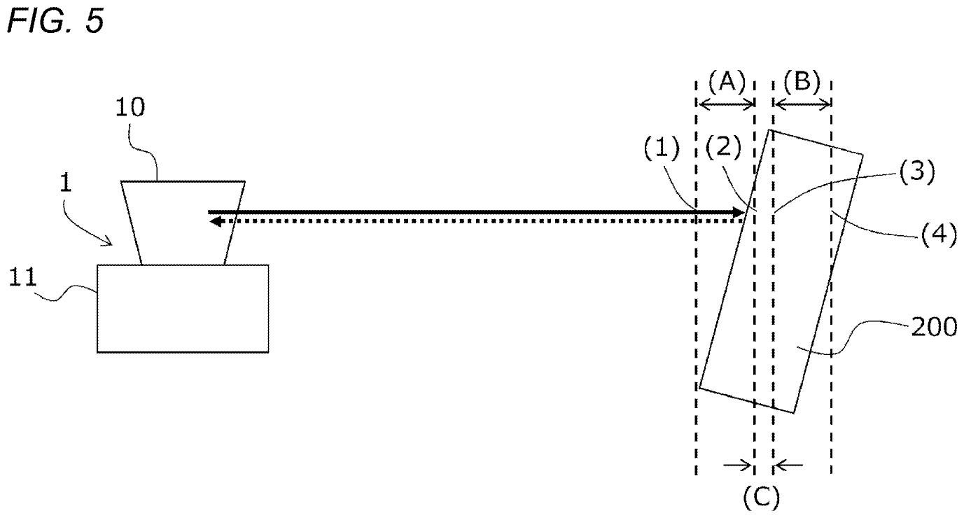

In FIG. 5, inclination of the frame 200 causes positional displacement of the frame 200, and the position of the frame 200 is included in the range (A) from the predetermined position (1) to the predetermined position (2). For this reason, the distance to the frame 200 is determined to be included in the range (A) from the distance L1 to the distance L2, and the processor 12 generates information regarding positional displacement of an object.

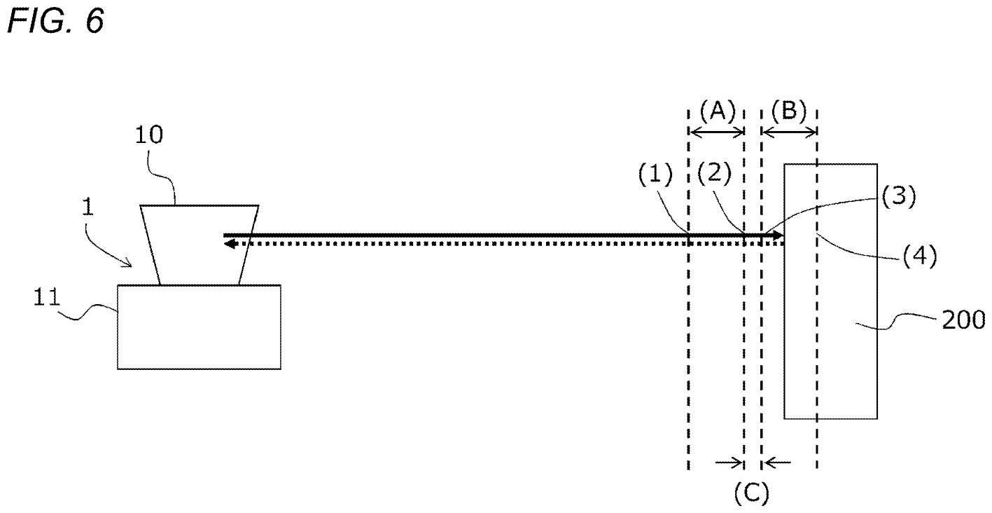

In FIG. 6, as the frame 200 moves, positional displacement of the frame 200 occurs, and the position of the frame 200 is included in the range (B) from the predetermined position (3) to the predetermined position (4). For this reason, the distance to the frame 200 is determined to be included in the range (B) from the distance L3 to the distance L4, and the processor 12 generates information regarding positional displacement of an object.

The information regarding positional displacement of an object is sent to the display device 13. The display device 13 displays information regarding positional displacement of an object. The information regarding positional displacement of an object may include information indicating that the position of an object is displaced. The information regarding positional displacement of an object may include information prompting the user to check an installation state of the object. When the user visually recognizes the information regarding positional displacement of an object displayed on the display device 13, the user can grasp the positional displacement of the object before an external device stops. As described above, according to the sensor unit 1, it is possible to grasp positional displacement of an object before an external device stops due to the positional displacement of the object.

Further, the processor 12 performs third determination to determine whether or not a distance to an object is included in a third distance range from the second predetermined distance to the third predetermined distance. In FIGS. 4 to 6, a range (C) from the distance L2 to the distance L3 is an example of the third distance range. The processor 12 determines whether or not a distance to the frame 200 is included in the range (C) from the distance L2 to the distance L3. That is, the processor 12 determines whether or not the position of the frame 200 is included in the range (C) from the predetermined position (2) to the predetermined position (3). In a case where a distance to an object is determined a predetermined number of times to be included in the third distance range, the processor 12 does not generate the information regarding positional displacement of an object. The predetermined number of times can be set to any number of times, and may be once or a plurality of times. In a case where a distance to an object is determined a predetermined number of times to be included in the third distance range, since positional displacement of the object does not occur, the processor 12 does not generate the information regarding positional displacement of the object.

Depending on a material of an object, a received light amount of light reflected by the object may drastically decrease or increase only when the object is slightly inclined. Further, if an attachable matter such as oil adheres to a surface of an object, a received light amount of light reflected by the object may drastically decrease or increase. In a case where a received light amount of light reflected by an object is excessive, abnormality is determined, and the sensor unit 1 outputs a stop signal to an external device. Further, in a case where a received light amount of light reflected by an object is equal to or less than a reference amount, receiving of the light is determined to be impossible, and the sensor unit 1 outputs a stop signal to an external device.

In view of the above, in the present invention, the sensor 10 measures a received light amount of light reflected by an object, and the processor 12 determines whether or not the received light amount measured by the sensor 10 is included in a predetermined range (predetermined received light amount range). In a case where a received light amount measured by the sensor 10 is determined a predetermined number of times not to be included in the predetermined range, the processor 12 generates information regarding fluctuation in a received light amount. The predetermined number of times can be set to any number of times, and may be once or a plurality of times.

The information on fluctuation in a received light amount is sent to the display device 13. The display device 13 displays information regarding fluctuation in a received light amount measured by the sensor 10. The information regarding fluctuation in a received light amount may include information indicating fluctuation in a received light amount. By the user visually recognizing the information regarding fluctuation in a received light amount displayed on the display device 13, the user can grasp fluctuation in the received light amount before an external device stops. As described above, according to the sensor unit 1, it is possible to grasp fluctuation in a received light amount before an external device stops due to the fluctuation in the received light amount.

Further, the processor 12 performs at least one of fourth determination of determining whether or not a distance to an object is shorter than the first predetermined distance and fifth determination of determining whether or not the distance to the object is longer than the fourth predetermined distance. In a case where a distance to an object is determined a predetermined number of times to be shorter than the first predetermined distance or in a case where the distance to the object is determined a predetermined number of times to be longer than the fourth predetermined distance, the processor 12 generates a stop signal for stopping an external device and sends the stop signal to the external device. The predetermined number of times can be set to any number of times, and may be once or a plurality of times. In a case where a distance to an object is shorter than the first predetermined distance or in a case where a distance to an object is longer than the fourth predetermined distance, since positional displacement of the object exceeds an allowable range, the processor 12 sends a stop signal to an external device. As described above, in a case where positional displacement of an object exceeds an allowable range, an external device can be stopped.

A setting tool (software program) of the sensor unit 1 is installed in a general personal computer, and the user can set an allowable range to the sensor unit 1 using the setting tool.

As described above, the sensor 10 can measure a plurality of directions. A distance to an object differs for each of a plurality of directions. For this reason, the processor 12 compares a distance to an object with the first predetermined distance, the second predetermined distance, the third predetermined distance, and the fourth predetermined distance set for each of a plurality of directions.

### Embodiment

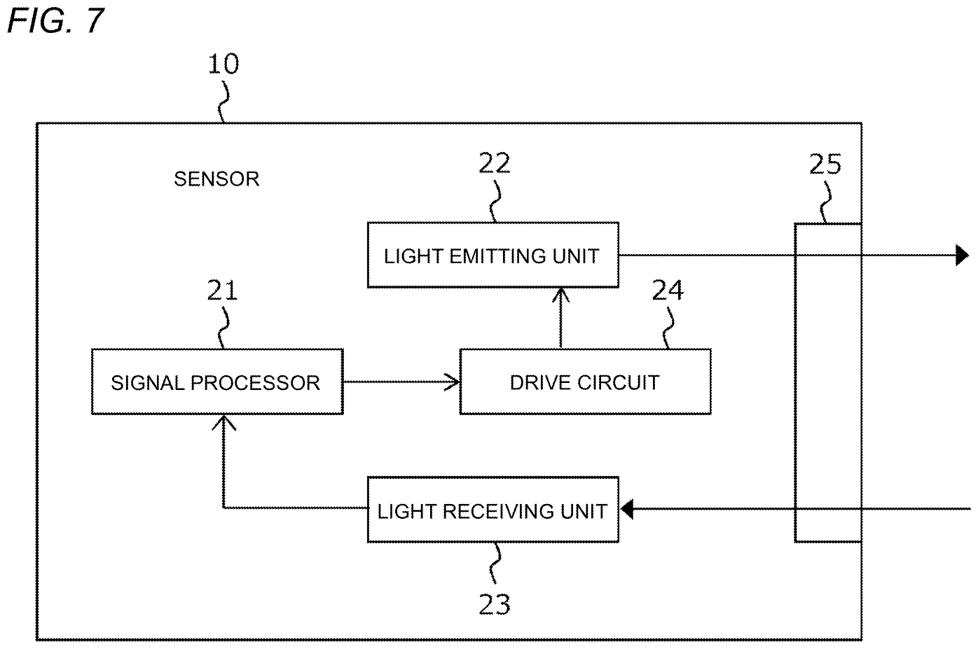

Hereinafter, an embodiment of the present invention will be described. FIG. 7 is a block diagram of the sensor 10. The sensor 10 includes a signal processor 21, a light emitting unit (transmitter) 22, a light receiving unit (receiver) 23, and a drive circuit 24. The light emitting unit 22 is, for example, a laser diode. When the signal processor 21 controls the drive circuit 24, drive current is applied to the light emitting unit 22, and the light emitting unit 22 emits pulsed light to transmit an optical signal. When the light emitting unit 22 transmits an optical signal, light is emitted from the light emitting unit 22, and the light is emitted from the window 101 to the outside via an optical component 25 such as a lens or a polygon mirror.

The light receiving unit 23 is, for example, a photodiode. Light emitted from the light emitting unit 22 to the outside and reflected by an object passes through the window 101 and is input as an optical signal to the light receiving unit 23 via the optical component 25. The light receiving unit 23 converts the optical signal into an electric signal according to intensity of the input optical signal and outputs the electric signal. The electric signal output from the light receiving unit 23 is input to the signal processor 21.

The signal processor 21 may measure a distance to an object by a ToF system. For example, the signal processor 21 measures a distance to an object on the basis of a time at which light is emitted, a time at which reflected light is received, and a speed of light. The signal processor 21 transmits measurement data to the processor 12.

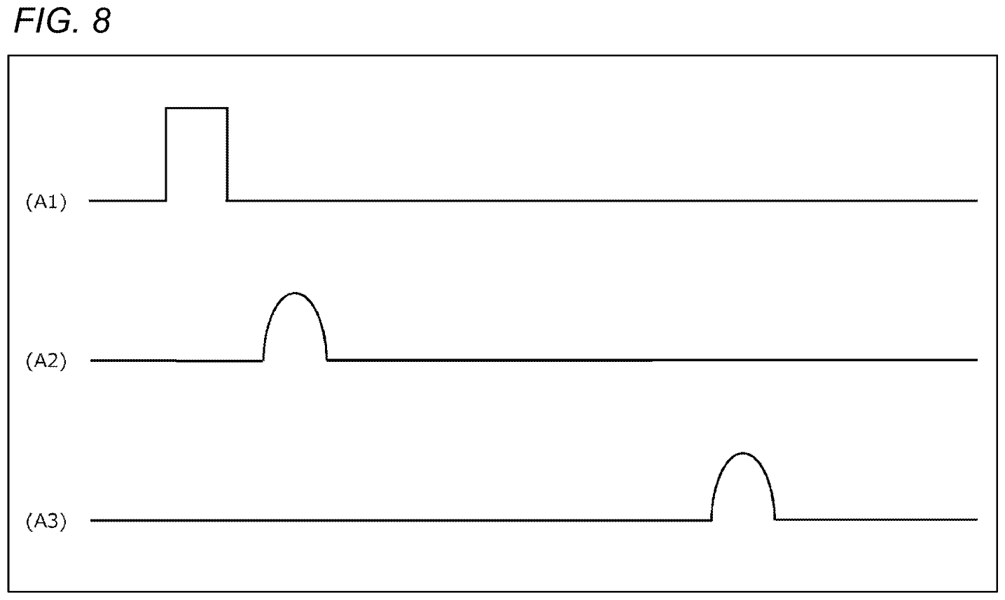

The signal processor 21 may measure a distance to an object using an electric signal of an analog wave (analog value). FIG. 8 is a diagram illustrating an example of a time chart of a signal. A time chart (A1) of FIG. 8 illustrates a light emission (instruction) signal input from the drive circuit 24 to the light emitting unit 22. Time charts (A2) and (A3) of FIG. 8 illustrate waveforms of an electric signal of an analog wave output from the light receiving unit 23. The time chart (A2) of FIG. 8 illustrates a waveform of an electric signal when emission light of the light emitting unit 22 is reflected by a target provided inside the sensor 10 and the light receiving unit 23 receives the reflected light. The time chart (A3) of FIG. 8 illustrates a waveform of an electric signal when emission light of the light emitting unit 22 is emitted to the outside of sensor 10, and the light receiving unit 23 receives the reflected light reflected by an object. As a time at which light is emitted, a value obtained by correcting a rising time of the waveform in (A1) of FIG. 8 using a time at which the waveform in (A2) of FIG. 8 is at a peak is used. As a time at which reflected light is received, a time at which the waveform in (A3) of FIG. 8 is at a peak is used.

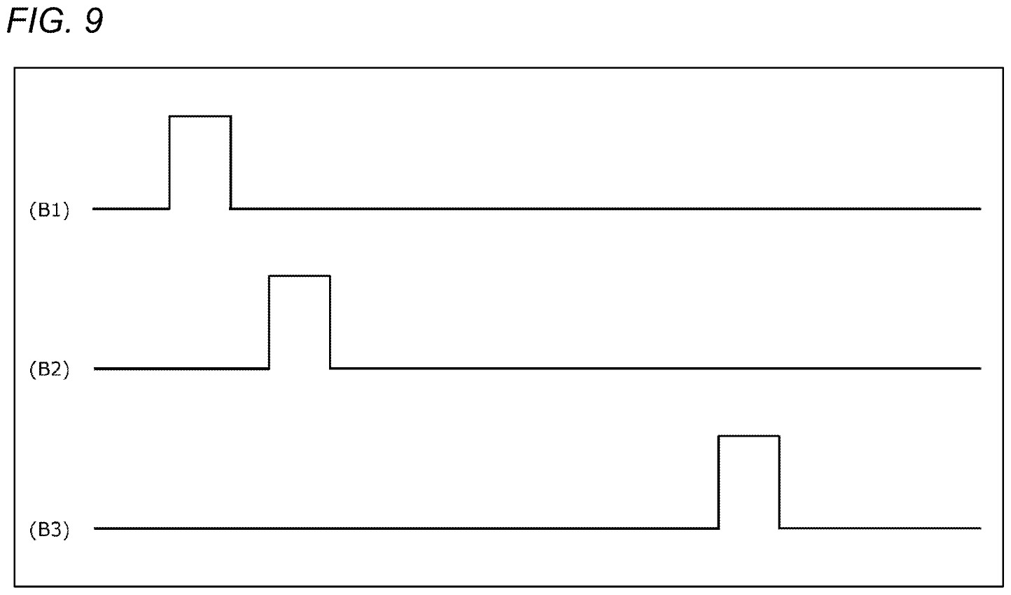

The signal processor 21 may measure a distance to an object using an electric signal of a rectangular wave (digital value). FIG. 9 is a diagram illustrating an example of a time chart of a signal. A time chart (B1) of FIG. 9 illustrates a light emission (instruction) signal input from the drive circuit 24 to the light emitting unit 22. Time charts (B2) and (B3) of FIG. 9 illustrate waveforms of an electric signal of a rectangular wave output from the light receiving unit 23. The time chart (B2) of FIG. 9 illustrates a waveform of an electric signal when emission light of the light emitting unit 22 is reflected by a target provided inside the sensor 10 and the light receiving unit 23 receives the reflected light. The time chart (B3) of FIG. 9 illustrates a waveform of an electric signal when emission light of the light emitting unit 22 is emitted to the outside of sensor 10, and the light receiving unit 23 receives the reflected light reflected by an object. In a case where a received light amount is equal to or more than a threshold, the light receiving unit 23 shapes the received light into an electric signal of a rectangular wave and outputs the electric signal. Further, the light receiving unit 23 may output an electric signal corresponding to intensity of the received light, and the electric signal output from the light receiving unit 23 may be input to the signal processor 21. In a case where a value of the electric signal output from the light receiving unit 23 is equal to or more than a threshold, the signal processor 21 shapes the electric signal output from the light receiving unit 23 into a rectangular wave. As a time at which light is emitted, a value obtained by correcting a rising time of the waveform in (B1) of FIG. 9 using a rising time of the waveform in (B2) of FIG. 9 is used. As a time at which reflected light is received, a rising time of the waveform in (B3) of FIG. 9 is used.

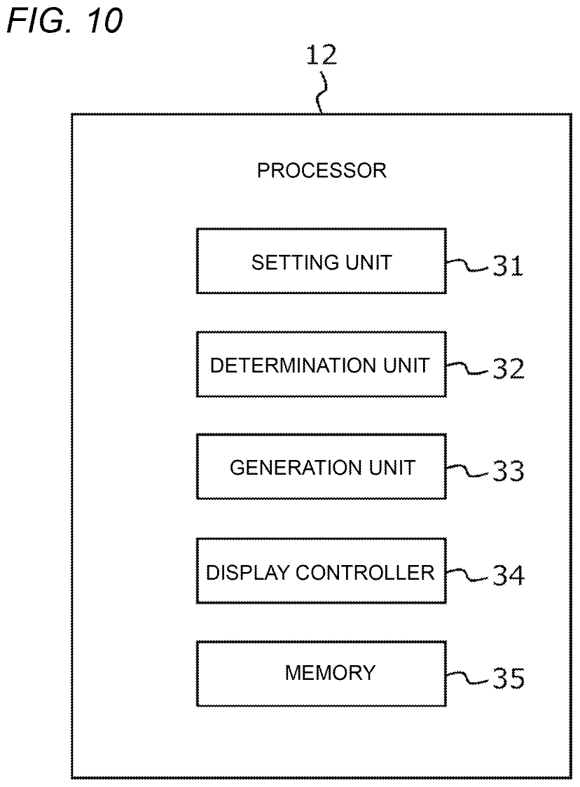

FIG. 10 is a functional block diagram of the processor 12. The processor 12 includes a setting unit 31, a determination unit 32, a generation unit 33, a display controller 34, and a memory 35 as main functions. Not all constituents of the processor 12 illustrated in FIG. 10 are essential, and the constituents of the processor 12 may be added or deleted as appropriate. For example, the processor 12 may include an output unit that outputs data and information generated by the generation unit 33. Further, the processor 12 may have a function as the signal processor 21.

The processor 12 is a device (controller) that controls the entire operation of the sensor unit 1 and controls the display device 13. The processor 12 acquires measurement data of a distance to an object measured by the sensor 10 from the sensor 10. The processor 12 may be configured by a dedicated device or a general-purpose computer. The processor 12 includes hardware resources such as a processor (CPU), a memory, a storage, and a communication I/F. The memory may be a RAM. The storage may be a non-volatile storage device (for example, ROM, flash memory, and the like). A function as each processor (functional unit) of the processor 12 is realized as a program stored in the storage is loaded into a memory and executed by the processor. Note that the configuration of the processor 12 is not limited to the above. For example, all or a part of the functions may be configured by a circuit such as ASIC or FPGA, or all or a part of the functions may be executed by a cloud server or another device.

The setting unit 31 performs various settings. The determination unit 32 determines whether or not a distance to an object is included in the first distance range, and determines whether or not the distance to the object is included in the second distance range. The determination unit 32 may perform at least one of the first determination of determining whether or not a distance to an object is included in the first distance range and the second determination of determining whether or not the distance to the object is included in the second distance range. Further, the determination unit 32 determines whether or not a received light amount measured by the sensor 10 is included in the predetermined range. Furthermore, the determination unit 32 performs the third determination to determine whether or not a distance to an object is included in the third distance range. The determination unit 32 performs at least one of the fourth determination of determining whether or not a distance to an object is shorter than the first predetermined distance and the fifth determination of determining whether or not the distance to the object is longer than the fourth predetermined distance.

In a case where a distance to an object is determined a predetermined number of times to be included in the first distance range or in a case where the distance to the object is determined a predetermined number of times to be included in the second distance range, the generation unit 33 generates information regarding positional displacement of the object. In a case where a distance to an object is determined a predetermined number of times to be included in the third distance range, the generation unit 33 does not generate the information regarding positional displacement of an object. In a case where a received light amount measured by the sensor 10 is determined a predetermined number of times not to be included in the predetermined range, the generation unit 33 generates information regarding fluctuation in a received light amount. In a case where a distance to an object is determined a predetermined number of times to be shorter than the first predetermined distance or in a case where the distance to the object is determined a predetermined number of times to be longer than the fourth predetermined distance, the generation unit 33 generates a stop signal for stopping an external device and sends the stop signal to the external device.

The display controller 34 controls the display device 13 on the basis of information generated by the generation unit 33. The display controller 34 controls the display device 13 on the basis of information regarding positional displacement of an object generated by the generation unit 33, so that the display device 13 displays the information regarding the positional displacement of the object. The display controller 34 controls the display device 13 on the basis of information regarding fluctuation in a received light amount generated by the generation unit 33, so that the display device 13 displays the information regarding the fluctuation in a received light amount.

The memory 35 stores various types of data and information. The memory 35 may include a RAM, a non-volatile storage device (for example, ROM, flash memory, and the like), and the like.

The display device 13 is a device that displays various types of data and information. The display device 13 is, for example, a liquid crystal display, an organic electro luminescence (EL) display, an indicating lamp, or the like. Further, the sensor unit 1 may include an input device such as an operation button and a touch panel. The touch panel may be integrated with the display device 13. The display device 13 may have at least one of a display having a screen for displaying data and information and an indicating lamp for displaying information by changing a glimmering pattern or a blinking pattern.

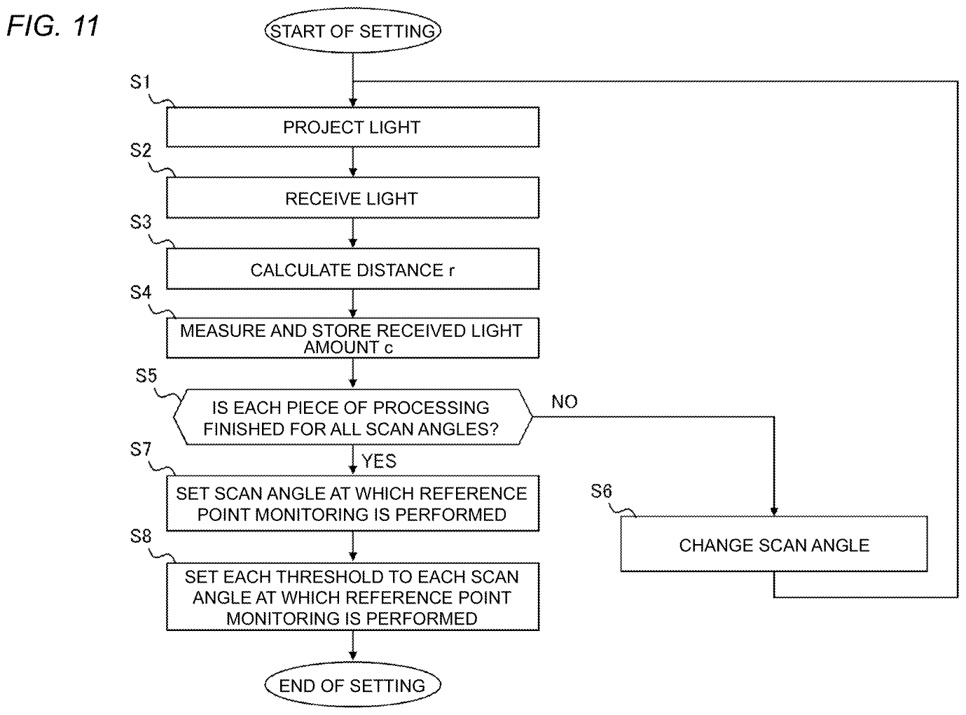

FIG. 11 is a flowchart illustrating an example of setting processing of reference point monitoring. For example, in a case where the sensor unit 1 is arranged for the first time or in a case where arrangement of the sensor unit 1 is changed, the setting processing is performed. Further, the setting processing of the reference point monitoring is performed in a state where a surface of an object to be measured (measurement target object) and a surface of the window 101 are cleaned. In S1, a predetermined scan angle is set, and the light emitting unit 22 emits (projects) light. In S2, the light receiving unit 23 receives light reflected by an object. In S3, the signal processor 21 calculates a distance (hereinafter referred to as distance R) to the object and stores the distance R in the memory 35. In S4, the sensor 10 measures a received light amount (hereinafter referred to as received light amount C) of light reflected by the object, and the setting unit 31 stores the received light amount C measured by the sensor 10 in the memory 35.

In S5, the setting unit 31 determines whether the calculation processing and the storing processing for the distance R and the measurement processing and the storing processing for the received light amount C are completed for all scan angles. In a case where each piece of the processing is not completed for all scan angles (S5; NO), the processing proceeds to S6, and the setting unit 31 changes the scan angle. As each piece of the processing of S1 to S4 is executed, the sensor 10 can measure a plurality of directions. In S7, the setting unit 31 sets a scan angle at which the reference point monitoring is performed. That is, the setting unit 31 sets a range (area) for detecting positional displacement of the object and fluctuation in a received light amount.

In S8, the setting unit 31 sets each threshold for each scan angle at which the reference point monitoring is performed. Specifically, the setting unit 31 sets a threshold (R−A, R+A) of a distance for the reference point monitoring, a threshold (R−B, R+B) of a distance at which a stable monitoring can be performed, and a threshold (C−C′, C+C′) of a received light amount by which stable monitoring can be performed. The threshold (R−A, R+A) is a threshold used when whether or not positional displacement of an object exceeds an allowable range is determined. The threshold (R−B, R+B) is a threshold used to detect positional displacement of an object. The threshold (R−A) is a value smaller than the threshold (R−B). The threshold (R+A) is a value larger than the threshold (R+B). The threshold (C−C′, C+C′) is a threshold used to detect fluctuation in a received light amount.

The threshold (R−A, R+A), the threshold (R−B, R+B), and the threshold (C−C′, C+C′) may be obtained by design, experiment, or simulation. A method of setting each value of (A), (B), and (C) in the threshold (R−A, R+A), the threshold (R−B, R+B), and the threshold (C−C′, C+C′) is not limited. Each value of (A), (B), and (C) in each threshold may be, for example, a constant or may vary depending on an algorithm. Further, another threshold (for example, a lower limit Ab and an upper limit At) may be further set with respect to an upper limit and a lower limit of the threshold (R−A, R+A), the threshold (R−B, R+B), and the threshold (C−C′, C+C′).

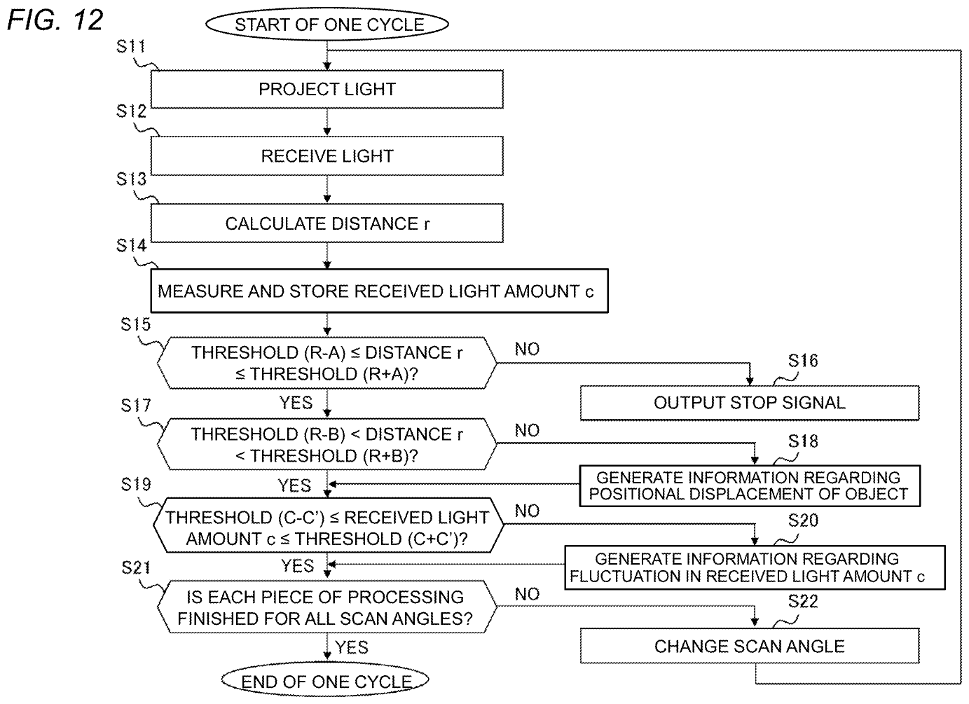

FIG. 12 is a flowchart illustrating an example of reference point monitoring processing. One cycle is started, a predetermined scan angle is set in S11, and the light emitting unit 22 emits (projects) light. In Step S12, the light receiving unit 23 receives light reflected by an object. In S13, the signal processor 21 calculates a distance to the object (hereinafter referred to as distance r). In S14, the sensor 10 measures a received light amount (hereinafter, referred to as received light amount c) reflected by the object. The sensor 10 transmits measurement data to the processor 12.

In S15, the determination unit 32 determines whether or not the distance r is equal to or more than the threshold (R−A) and equal to or less than the threshold (R+A). In a case where the distance r is smaller than the threshold (R−A) or in a case where the distance r is larger than the threshold (R+A) (S15; NO), the processing proceeds to S16. The determination unit 32 may also perform at least one of determination as to whether or not the distance r is smaller than the threshold (R−A) and determination as to whether or not the distance r is larger than the threshold (R+A).

In S16, the generation unit 33 generates and outputs a stop signal for stopping an external device. The stop signal is sent to the external device, and the external device receives the stop signal, so that the external device stops. The generation unit 33 may send a stop signal to an external device via an output signal switching device (OSSD) wired and connected to the sensor unit 1. The OSSD is a device for outputting a safety control signal indicating one of an on state and an off state. The generation unit 33 may transmit a stop signal to an external device by wired communication (for example, EtherNet (registered trademark) communication) or wireless communication.

On the other hand, in a case where the distance r is equal to or more than the threshold (R−A) and the distance r is equal to or less than the threshold (R+A) (S15; YES), the processing proceeds to S17. In S17, the determination unit 32 determines whether or not the distance r is larger than the threshold (R−B) and the distance r is smaller than the threshold (R+B). In a case where the distance r is equal to or less than the threshold (R−B), or in a case where the distance r is equal to or more than the threshold (R+B) (S17; NO), the processing proceeds to S18. The determination unit 32 may also perform at least one of determination as to whether or not the distance r is larger than the threshold (R−B) and determination as to whether or not the distance r is smaller than the threshold (R+B). In a case where the distance r is equal to or more than the threshold (R−A) and the distance r is equal to or less than the threshold (R−B), the determination unit 32 determines that the distance r is included in the first distance range. Further, in a case where the distance r is equal to or more than the threshold (R+B) and the distance r is equal to or less than the threshold (R+A), the determination unit 32 determines that the distance r is included in the second distance range.

In S18, the generation unit 33 generates information regarding positional displacement of an object. The display device 13 displays information regarding positional displacement of an object. The information regarding positional displacement of an object may include at least one of a letter, a number, a symbol, a character string, a number string, a pictogram, a graph, and an image. For example, in a case where a number, a symbol, or the like is displayed on the display device 13 as the information regarding positional displacement of an object, the user can grasp that the position of the object is displaced by checking using a manual or the like. Further, the display device 13 may display the information regarding positional displacement of an object by a glimmering pattern or a blinking pattern. After the processing of S18 is executed, the processing proceeds to S19.

On the other hand, in a case where the distance r is larger than the threshold (R−B) and the distance r is smaller than the threshold (R+B) (S17; YES), the processing proceeds to S19. In a case where the distance r is larger than the threshold (R−B) and the distance r is smaller than the threshold (R+B), the determination unit 32 determines that the distance r is included in the third distance range, and the generation unit 33 does not generate the information regarding positional displacement of an object. In S19, the determination unit 32 determines whether or not the received light amount c is equal to or more than the threshold (C−C′) and whether or not the received light amount c is equal to or less than the threshold (C+C′). In a case where the received light amount c is smaller than the threshold (C−C′) or in a case where the received light amount c is larger than the threshold (C+C′) (S19; NO), the processing proceeds to S20. In a case where the received light amount c is smaller than the threshold (C−C′) or in a case where the received light amount c is larger than the threshold (C+C′), the determination unit 32 determines that the received light amount c is not included in the predetermined range.

In S20, the generation unit 33 generates information regarding fluctuation in the received light amount c. The display device 13 displays the information regarding fluctuation in the received light amount c. The information regarding fluctuation in the received light amount c may include at least one of a letter, a number, a symbol, a character string, a number string, a pictogram, a graph, and an image. For example, in a case where a number, a symbol, or the like is displayed on the display device 13 as the information regarding fluctuation in the received light amount c, the user can grasp that the received light amount c fluctuates by checking a manual or the like. Further, the display device 13 may display the information regarding fluctuation in the received light amount c by a glimmering pattern or a blinking pattern.

The information regarding fluctuation in the received light amount c may include information indicating decrease in the received light amount c. In a case where the received light amount c is equal to or less than the threshold (C−C′), the generation unit 33 may generate the information indicating decrease in the received light amount c. The display device 13 may display the information indicating decrease in the received light amount c. The information regarding fluctuation in the received light amount c may include information indicating increase in the received light amount c. In a case where the received light amount c is equal to or more than the threshold (C+C′), the generation unit 33 may generate the information indicating increase in the received light amount c. The display device 13 may display the information indicating increase in the received light amount c. After the processing of S20 is executed, the processing proceeds to S21.

On the other hand, in a case where the received light amount c is equal to or more than the threshold (C−C′) and the received light amount c is equal to or less than the threshold (C+C′) (S19; YES), the processing proceeds to S21. In a case where the received light amount c is equal to or more than the threshold (C−C′) and the received light amount c is equal to or less than the threshold (C+C′), the determination unit 32 determines that the received light amount c is included in the predetermined range.

In S21, the determination unit 32 determines whether each pieces of the processing of S11 to S15, S17, and S19 is completed for all scan angles. For example, in a case where each piece of the processing is not completed for all scan angles (Step S21; NO), the processing proceeds to S22, and the determination unit 32 changes the scan angle. One cycle ends when each pieces of the processing is completed for all scan angles. A plurality of cycles may be executed at predetermined intervals (regular or irregular intervals).

By executing each pieces of the processing of S11 to S14 for a plurality of scan angles, the sensor 10 measures a plurality of directions. By executing the processing of S15 for a plurality of scan angles, the determination unit 32 performs at least one of the fourth determination and the fifth determination for a plurality of directions. In a case where a distance to an object in one of a plurality of directions is determined a predetermined number of times to be shorter than the first predetermined distance or in a case where the distance to the object in one of a plurality of directions is determined a predetermined number of times to be longer than the fourth predetermined distance, the generation unit 33 generates a stop signal for stopping an external device and sends the stop signal to the external device. By the above, in a case where positional displacement of an object in one of a plurality of directions exceeds an allowable range, an external device can be stopped.

By executing each piece of the processing of S15 and S17 for a plurality of scan angles, the determination unit 32 performs at least one of the first determination and the second determination for a plurality of directions. In a case where the distance r in one of a plurality of directions is determined a predetermined number of times to be included in the first distance range or in a case where the distance r in one of a plurality of directions is determined a predetermined number of times to be included in the second distance range, the generation unit 33 generates information regarding positional displacement of an object. The user can grasp the positional displacement of the object in one of a plurality of directions. By executing each piece of the processing of S15 and S17 for a plurality of scan angles, the determination unit 32 performs the third determination for a plurality of directions. In a case where the distance r in one of a plurality of directions for which the third determination is performed is determined a predetermined number of times to be included in the third distance range, the generation unit 33 does not generate the information regarding positional displacement of an object.

As the processing of S19 is executed for a plurality of scan angles, the determination unit 32 determines whether or not the received light amount c in a plurality of directions is included in the predetermined range. In a case where the received light amount c in one of a plurality of directions is determined a predetermined number of times not to be included in the predetermined range, the generation unit 33 generates information regarding fluctuation in the received light amount c. The user can grasp that the received light amount c in one of a plurality of directions fluctuates.

At least one of the determination unit 32 and the generation unit 33 may have a counter function. At least one of the determination unit 32 and the generation unit 33 may count the number of times of negative determination (NO determination) and positive determination (YES determination) in each piece of the processing of S15, S17, and S19.

A first processing example using the counting function will be described. At least one of the determination unit 32 and the generation unit 33 counts the number of times of negative determinations and positive determinations in one cycle. In the processing of S15, even if negative determination is made, the processing proceeds to S17 without proceeding to S16. In a case where negative determination is made in the processing of S15 for a plurality of consecutive scan angles in one cycle, the generation unit 33 generates and outputs a stop signal. In a case where the distance r in at least two of a plurality of directions is determined a predetermined number of times to be shorter than the first predetermined distance, the generation unit 33 may generate a stop signal and transmit the stop signal to an external device. In a case where the distance r in at least two of a plurality of directions is determined a predetermined number of times to be shorter than the fourth predetermined distance, the generation unit 33 may generate a stop signal and transmit the stop signal to an external device. By the above, in a case where positional displacement of an object in at least two of a plurality of directions exceeds an allowable range, an external device can be stopped.

Further, in the processing of S17, even if negative determination is made, the processing proceeds to S19 without proceeding to S18. In a case where positive determination is made in the processing of S15 and negative determination is made in the processing of S17 for a plurality of consecutive scan angles in one cycle, the processing proceeds to S18, and the generation unit 33 generates information regarding positional displacement of an object. In other words, in a case where positive determination is made in each piece of the processing of S15 and S17 for a plurality of consecutive scan angles in one cycle, the generation unit 33 does not generate information regarding positional displacement of an object. In a case where the distance r in at least two of a plurality of directions is determined a predetermined number of times to be included in the first distance range or in a case where the distance r in at least two of a plurality of directions is determined a predetermined number of times to be included in the second distance range, the generation unit 33 may generate information regarding positional displacement of an object. The user can grasp the positional displacement of the object in at least two of a plurality of directions.

Further, in the processing of S19, even if negative determination is made, the processing proceeds to S21 without proceeding to S20. In a case where negative determination is made in the processing of S19 for a plurality of consecutive scan angles in one cycle, the processing proceeds to S20, and the generation unit 33 generates information regarding fluctuation in the received light amount c. In a case where the received light amount c in at least two of a plurality of directions is determined a predetermined number of times not to be included in the predetermined range, the generation unit 33 may generate information regarding fluctuation in the received light amount c. The user can grasp that the received light amount c in at least two direction of a plurality of directions fluctuates.

A second processing example using the counting function will be described. At least one of the determination unit 32 and the generation unit 33 counts the number of times of negative determination and positive determination for the same scan angle in a plurality of cycles. In the processing of S15, even if negative determination is made, the processing proceeds to S17 without proceeding to S16. In a case where negative determination is made in the processing of S15 for the same scan angle over two or more cycles, the generation unit 33 generates and outputs a stop signal. In a case where the distance r in one of a plurality of directions is determined two times or more to be shorter than the first predetermined distance, the generation unit 33 may generate a stop signal and transmit the stop signal to an external device. In a case where the distance r in one of a plurality of directions is determined two times or more to be longer than the fourth predetermined distance, the generation unit 33 may generate a stop signal and transmit the stop signal to an external device.

Further, in the processing of S17, even if negative determination is made, the processing proceeds to S19 without proceeding to S18. In a case where positive determination is made in the processing of S15 and negative determination is made in the processing of S17 for the same scan angle over two or more cycles, the generation unit 33 generates information regarding positional displacement of an object. In other words, in a case where positive determination is made in each piece of the processing of S15 and S17 for the same scan angle over two or more cycles, the generation unit 33 does not generate information regarding positional displacement of an object. In a case where the distance r in one of a plurality of directions is determined two or more times to be included in the first distance range or in a case where the distance r in one of a plurality of directions is determined two or more times to be included in the second distance range, the generation unit 33 may generate information regarding positional displacement of an object.

Further, in the processing of S19, even if negative determination is made, the processing proceeds to S21 without proceeding to S20. In a case where negative determination is made in the processing of S19 for the same scan angle over two or more cycles, the generation unit 33 generates information regarding fluctuation in the received light amount c. In a case where the received light amount c in one of a plurality of directions is determined two or more times not to be included in the predetermined range, the generation unit 33 may generate information regarding fluctuation in the received light amount c.

The generation unit 33 may transmit at least one of information regarding positional displacement of an object and information regarding fluctuation in the received light amount c to an external display device by wired communication or wireless communication. The external display device is a display separate from the sensor unit 1. The external display device is, for example, a liquid crystal display, an organic EL display, or the like. The external display device may be provided in an information processor such as a personal computer, a tablet, or a smartphone.

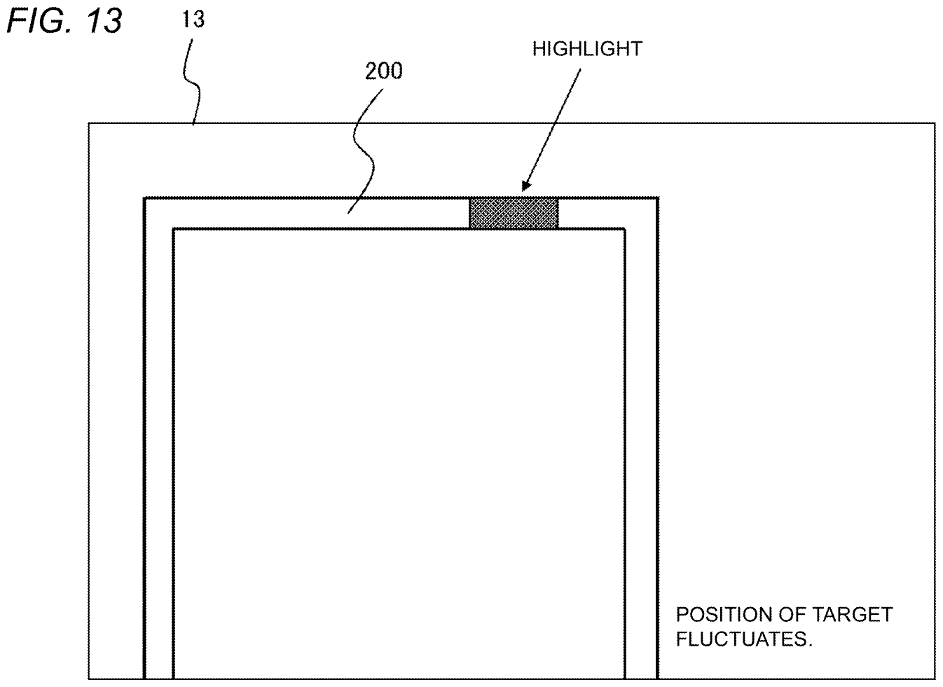

The information regarding positional displacement of an object may include an outer shape of the object and a location where the positional displacement of the object occurs. FIG. 13 is a diagram illustrating an example of a screen of the display device 13. For example, as illustrated in FIG. 13, a location where positional displacement of the frame 200 occurs may be highlighted, and an outer shape of the frame 200 and the location where the positional displacement of the frame 200 occurs may be displayed on a screen of the display device 13. In the example illustrated in FIG. 13, information indicating that a position of the frame 200 is displaced is displayed on the screen of the display device 13.

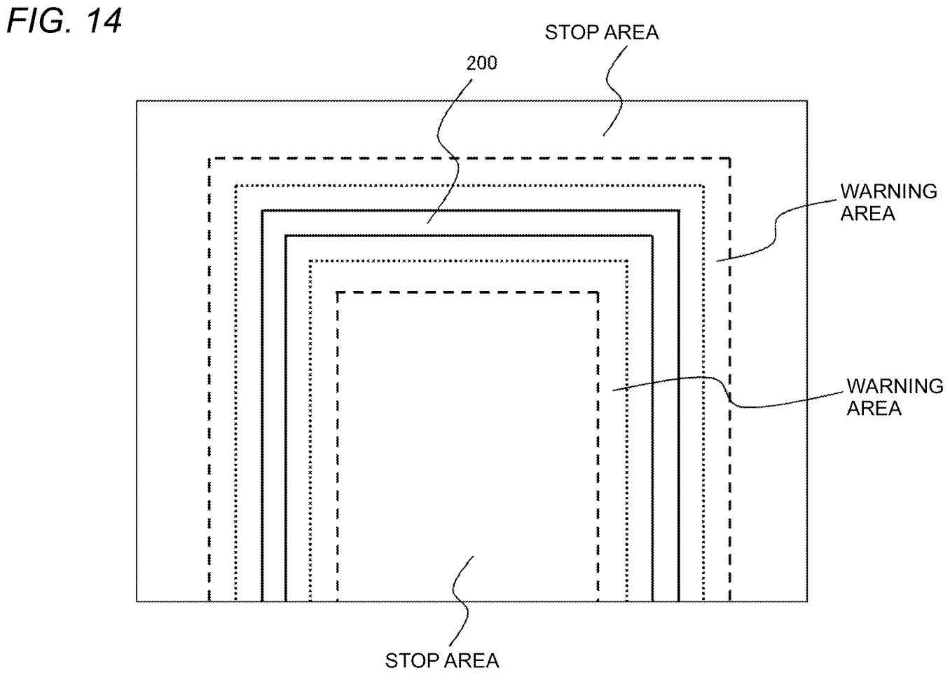

Further, the user may set a stop area and a warning area on a screen of an external display device using a setting tool. FIG. 14 is a diagram illustrating an example of setting of a stop area and a warning area. FIG. 14 illustrates an outer shape of the frame 200, a stop area, and a warning area. The user sets a range of a stop area and a range of a warning area using the setting tool. The range of a warning area may be an allowable range. The user may set the threshold (R−A, R+A) based on a stop area, and may set the threshold (R−B, R+B) based on a warning area.

### Others

The above embodiment merely exemplarily describes the configuration example of the present invention. The present invention is not limited to the specific aspect described above, and various variations can be made within the scope of the technical idea. For example, the sensor unit 1 uses a sensor of a scanner type, but the configuration is not limited to this, and a sensor of a non-scanner type may be used. When a sensor of a non-scanner type is used as the sensor unit 1, a plurality of the sensor units 1 may be provided at an object or in the vicinity of the object.

Each piece of the processing described above may be regarded as a method executed by a computer. Further, a program for causing a computer to execute each piece of the processing described above may be provided to the computer through a network or from a computer-readable recording medium or the like that holds data non-temporarily.

### Supplementary Note 1

A sensor unit (1) including:

a sensor (10) configured to measure a distance to an object by observing an electromagnetic wave reflected by the object;

a determination unit (32) configured to perform at least one of first determination of determining whether or not the distance to the object is included in a first distance range from a first predetermined distance to a second predetermined distance longer than the first predetermined distance and second determination of determining whether or not the distance to the object is included in a second distance range from a third predetermined distance longer than the second predetermined distance to a fourth predetermined distance longer than the third predetermined distance;

a generation unit (33) configured to generate information regarding positional displacement of the object in a case where the distance to the object is determined a predetermined number of times to be included in the first distance range or in a case where the distance to the object is determined a predetermined number of times to be included in the second distance range; and

a display (13) configured to display the information regarding positional displacement of the object.

### Supplementary Note 2

A control method of the sensor unit (1), the method including:

a measuring step of measuring a distance to an object by observing an electromagnetic wave reflected by the object;

a determining step of performing at least one of first determination of determining whether or not the distance to the object is included in a first distance range from a first predetermined distance to a second predetermined distance longer than the first predetermined distance and second determination of determining whether or not the distance to the object is included in a second distance range from a third predetermined distance longer than the second predetermined distance to a fourth predetermined distance longer than the third predetermined distance;

a generating step of generating information regarding positional displacement of the object in a case where the distance to the object is determined a predetermined number of times to be included in the first distance range or in a case where the distance to the object is determined a predetermined number of times to be included in the second distance range; and

a displaying step of displaying the information regarding positional displacement of the object on the display (13).

### Supplementary Note 3

A non-transitory computer readable medium storing a program that causes a processor to execute:

an acquiring step of acquiring measurement data from the sensor (10) that measures a distance to an object by observing an electromagnetic wave reflected by the object;

a determining step of performing at least one of first determination of determining whether or not the distance to the object is included in a first distance range from a first predetermined distance to a second predetermined distance longer than the first predetermined distance and second determination of determining whether or not the distance to the object is included in a second distance range from a third predetermined distance longer than the second predetermined distance to a fourth predetermined distance longer than the third predetermined distance;

a generating step of generating information regarding positional displacement of the object in a case where the distance to the object is determined a predetermined number of times to be included in the first distance range or in a case where the distance to the object is determined a predetermined number of times to be included in the second distance range; and

a displaying step of displaying the information regarding positional displacement of the object on the display (13).

1. A sensor unit comprising:
a sensor configured to measure a distance to an object by observing an electromagnetic wave reflected by the object;
a determination unit configured to perform at least one of first determination of determining whether or not the distance to the object is included in a first distance range from a first predetermined distance to a second predetermined distance longer than the first predetermined distance and second determination of determining whether or not the distance to the object is included in a second distance range from a third predetermined distance longer than the second predetermined distance to a fourth predetermined distance longer than the third predetermined distance;
a generation unit configured to generate information regarding positional displacement of the object in a case where the distance to the object is determined a predetermined number of times to be included in the first distance range or in a case where the distance to the object is determined a predetermined number of times to be included in the second distance range; and
a display configured to display the information regarding positional displacement of the object.

2. The sensor unit according to claim 1, wherein
the determination unit is configured to perform third determination to determine whether or not the distance to the object is included in a third distance range from the second predetermined distance to the third predetermined distance, and
the generation unit is configured not to generate the information regarding positional displacement of the object in a case where the distance to the object is determined a predetermined number of times to be included in the third distance range.

3. The sensor unit according to claim 1, wherein
an electromagnetic wave reflected by the object includes light,
the sensor is configured to measure a received light amount of light reflected by the object,
the determination unit is configured to determine whether or not the received light amount is included in a predetermined range,
the generation unit is configured to generate information regarding fluctuation in the received light amount in a case where the received light amount is determined a predetermined number of times not to be included in the predetermined range, and
the display is configured to display the information regarding fluctuation in the received light amount.

4. The sensor unit according to claim 3, wherein
the sensor is configured to measure a plurality of directions,
the determination unit is configured to determine whether or not the received light amount in the plurality of directions is included in the predetermined range, and
the generation unit is configured to generate the information regarding fluctuation in the received light amount in a case where the received light amount in one of the plurality of directions is determined a predetermined number of times not to be included in the predetermined range.

5. The sensor unit according to claim 3, wherein
the sensor is configured to measure a plurality of directions,
the determination unit is configured to determine whether or not the received light amount in the plurality of directions is included in the predetermined range, and
the generation unit is configured to generate the information regarding fluctuation in the received light amount in a case where the received light amount in at least two of the plurality of directions is determined a predetermined number of times not to be included in the predetermined range.

6. The sensor unit according to claim 1, wherein
the sensor is configured to measure a plurality of directions,
the determination unit is configured to perform at least one of the first determination and the second determination on the plurality of directions, and
the generation unit is configured to generate the information regarding positional displacement of the object in a case where the distance to the object in one of the plurality of directions is determined a predetermined number of times to be included in the first distance range, or in a case where the distance to the object in one of the plurality of directions is determined a predetermined number of times to be included in the second distance range.

7. The sensor unit according to claim 1, wherein
the sensor is configured to measure a plurality of directions,
the determination unit is configured to perform at least one of the first determination and the second determination on the plurality of directions, and
the generation unit is configured to generate the information regarding positional displacement of the object in a case where the distance to the object in at least two of the plurality of directions is determined a predetermined number of times to be included in the first distance range, or in a case where the distance to the object in at least two of the plurality of directions is determined a predetermined number of times to be included in the second distance range.

8. The sensor unit according to claim 1, wherein
the determination unit is configured to perform at least one of fourth determination of determining whether or not the distance to the object is shorter than the first predetermined distance and fifth determination of determining whether or not the distance to the object is longer than the fourth predetermined distance, and
the generation unit is configured to generate a stop signal for stopping an external device and sends the stop signal to the external device in a case where the distance to the object is determined a predetermined number of times to be shorter than the first predetermined distance or in a case where the distance to the object is determined a predetermined number of times to be longer than the fourth predetermined distance.

9. The sensor unit according to claim 8, wherein
the sensor is configured to measure a plurality of directions,
the determination unit is configured to perform at least one of the fourth determination and the fifth determination on the plurality of directions, and
the generation unit is configured to generate the stop signal and sends the stop signal to the external device in a case where the distance to the object in one of the plurality of directions is determined a predetermined number of times to be shorter than the first predetermined distance or in a case where the distance to the object in one of the plurality of directions is determined a predetermined number of times to be longer than the fourth predetermined distance.

10. The sensor unit according to claim 8, wherein
the sensor is configured to measure a plurality of directions,
the determination unit is configured to perform at least one of the fourth determination and the fifth determination on the plurality of directions, and
the generation unit is configured to generate the stop signal and sends the stop signal to the external device in a case where the distance to the object in at least two of the plurality of directions is determined a predetermined number of times to be shorter than the first predetermined distance or in a case where the distance to the object in at least two of the plurality of directions is determined a predetermined number of times to be longer than the fourth predetermined distance.

11. A control method of a sensor unit, the method comprising:
a measuring step of measuring a distance to an object by observing an electromagnetic wave reflected by the object;
a determining step of performing at least one of first determination of determining whether or not the distance to the object is included in a first distance range from a first predetermined distance to a second predetermined distance longer than the first predetermined distance and second determination of determining whether or not the distance to the object is included in a second distance range from a third predetermined distance longer than the second predetermined distance to a fourth predetermined distance longer than the third predetermined distance;
a generating step of generating information regarding positional displacement of the object in a case where the distance to the object is determined a predetermined number of times to be included in the first distance range or in a case where the distance to the object is determined a predetermined number of times to be included in the second distance range; and
a displaying step of displaying the information regarding positional displacement of the object on a display.

12. A non-transitory computer readable medium storing a program that causes a processor to execute:
an acquiring step of acquiring measurement data from a sensor that measures a distance to an object by observing an electromagnetic wave reflected by the object;
a determining step of performing at least one of first determination of determining whether or not the distance to the object is included in a first distance range from a first predetermined distance to a second predetermined distance longer than the first predetermined distance and second determination of determining whether or not the distance to the object is included in a second distance range from a third predetermined distance longer than the second predetermined distance to a fourth predetermined distance longer than the third predetermined distance;
a generating step of generating information regarding positional displacement of the object in a case where the distance to the object is determined a predetermined number of times to be included in the first distance range or in a case where the distance to the object is determined a predetermined number of times to be included in the second distance range; and
a displaying step of displaying the information regarding positional displacement of the object on a display.
